(19) United States
(12) Patent Application Publication
(10) Pub. No.: US 2026/0320942 A1
(43) Pub. Date: Oct. 15, 2026

(54) DYNAMICALLY CHANGING AVATAR BODIES IN A VIRTUAL EXPERIENCE

(71) Applicant: Roblox Corporation, San Mateo, CA (US)

(72) Inventors: Adam Tucker BURR, Suffern, NY (US); Si CHEN, San Mateo, CA (US); Lukas KUCZYNSKI, San Mateo, CA (US); Adrian Paul LONGLAND, Redwood City, CA (US); David REDKEY, San Mateo, CA (US)

(73) Assignee: Roblox Corporation, San Mateo, CA (US)

(21) Appl. No.: 19/107,519

(22) PCT Filed: Aug. 13, 2024
(86) PCT No.: PCT/US2024/042103

§ 371 Date: Feb. 27, 2025

Related U.S. Application Data
(60) Provisional application No. 63/532,556, filed on Aug. 14, 2023.

(51) Int. Cl. G06T 19/20; G06T 13/40

(52) U.S. Cl. CPC G06T 19/20; G06T 13/40; G06T 2200/24; G06T 2210/16; G06T 2219/2021

(57) ABSTRACT

Some implementations relate to methods, systems, and computer-readable media to dynamically change an avatar body during runtime while an avatar associated with the avatar body is participating in a virtual experience. In some implementations, the method includes identifying a first avatar body having a first body cage, identifying a target avatar body having a target body cage, and performing an interpolation between the first body cage and the target body cage to obtain a second body cage corresponding to a second avatar body to provide a transformation of the first avatar body into the second avatar body. The avatar body can also be changed in a configuration environment. Changing the avatar body may involve interpolating between body cages of a pair of cages, or by directly manipulating the body cage of the avatar body.

### CROSS-REFERENCE TO RELATED APPLICATIONS

This application is a § 371 national stage of PCT International Application No. PCT/US2024/042103, entitled “DYNAMICALLY CHANGING AVATAR BODIES IN A VIRTUAL EXPERIENCE,” filed Aug. 13, 2024, claiming priority to U.S. Provisional Application No. 63/532,556, entitled “DYNAMICALLY CHANGING AVATAR BODIES IN A VIRTUAL EXPERIENCE,” filed on Aug. 14, 2023, the content of which are incorporated herein in their entirety.

### TECHNICAL FIELD

This disclosure relates generally to computer graphics, and more particularly but not exclusively, relates to methods, systems, and computer readable media to dynamically change an avatar body (including representations of clothing worn by the avatar body) in a three-dimensional (3D) virtual environment.

### BACKGROUND

Multi-user electronic gaming or other types of virtual experience environments may involve the use of avatars, which represent the users in the virtual experience. Different three-dimensional (3D) avatars differ in geometry/shapes from one avatar to another. For example, avatars may have different body shapes (e.g., tall, short, muscular, thin, etc.), may be of different types (e.g., male, female, human, animal, alien, etc.), may have any number and types of limbs, etc. Avatars may be customizable with respect to multiple pieces of clothing and/or accessories worn by the avatar (e.g., shirt worn over the torso, jacket worn over the shirt, scarf worn over the jacket, hat worn over the head, etc.).

It can be difficult to obtain satisfactory results, in a computationally efficient manner, when users wish to change some visual aspect of their respective avatar's body and/or clothing (including accessories) worn by the avatar body while participating in a virtual experience or other type of 3D environment.

Some implementations were conceived in light of the above.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

Implementations of the present disclosure relate to techniques to dynamically change a visual aspect of a user's avatar (e.g., the visual appearance of an avatar associated with the user as the user participates in a virtual experience). The entire (original) avatar body can be changed or otherwise transformed in its entirety to the new (different) avatar body, or only regions/portions of the original avatar body can be selectively changed (e.g., just the head or other body part) while other regions/portions of the original avatar body remain unchanged. Various techniques also provide specific ways to accomplish aspects of the dynamic change such as skin morphing and facial action coding system (FACS) pose morphing in near-real time by using techniques that manage computational resources effectively.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

According to one aspect, a computer-implemented method to modify three-dimensional (3D) avatar bodies is provided, the computer-implemented method comprising: identifying a first avatar body having a first body cage; identifying a target avatar body having a target body cage; and performing an interpolation between the first body cage and the target body cage to obtain a second body cage corresponding to a second avatar body to provide a transformation of the first avatar body into the second avatar body.

Various implementations of the computer-implemented method are described herein.

In some implementations, performing the interpolation comprises performing the interpolation to generate the second body cage that completely matches the target body cage to provide a full transformation.

In some implementations, performing the interpolation comprises transforming the first avatar body into the second avatar body that is a blend between the first avatar body and the target avatar body to provide a partial transformation.

In some implementations, performing the interpolation comprises morphing a portion of the first avatar body that is less than an entirety of the first avatar body.

In some implementations, morphing the portion of the first avatar body that is less than the entirety of the first avatar body comprises morphing the portion of the first avatar body to perform a partial transformation of the portion of the first avatar body.

In some implementations, the first avatar body is part of a virtual experience, performing the interpolation is performed while the avatar participates in the virtual experience, and the target avatar body is selected from a plurality of target avatar bodies in the virtual experience.

In some implementations, performing the interpolation is performed in a configuration environment and the target avatar body is selected from a plurality of target avatar bodies in a library in the configuration environment.

In some implementations, the configuration environment includes a transformation tool that enables a user to control an amount of the transformation of the first avatar body to obtain the second avatar body, and performing the interpolation is based on the amount of the transformation.

In some implementations, the computer-implemented method further comprises identifying a rig of the first avatar body, the rig comprising identifying a skeleton of the first avatar body and a skinning of the first avatar body; after performing the interpolation, updating the rig of the first avatar body to correspond to the second body cage; and animating the first avatar body by moving a skeleton of the updated rig and deforming a skinning of the updated rig.

In some implementations, moving the skeleton of the updated rig and deforming the skinning of the updated rig comprises reusing skin weights from the skinning of the first avatar body based on determining areas of skinning of the updated rig that are influenced by bones in the skeleton of the first avatar body.

According to another aspect, a computer-implemented method to modify three-dimensional (3D) avatar bodies is provided, the computer-implemented method comprising: identifying a first avatar body having a corresponding first body cage; and performing a manipulation of the first body cage to generate a second body cage corresponding to a second avatar body to provide a transformation of the first avatar body into the second avatar body, wherein the manipulating comprises repositioning portions of the first body cage.

Various implementations of the computer-implemented method are described herein.

In some implementations, performing the manipulation is performed in a configuration environment, and wherein the configuration environment includes a transformation tool that enables a user to control aspects of the manipulation of the first body cage to obtain the second body cage, and wherein performing the manipulation is based on the aspects of the manipulation.

In some implementations, the computer-implemented method further comprises identifying a rig of the first avatar body, the rig comprising identifying a skeleton of the first avatar body and a skinning of the first avatar body; after performing the manipulation, updating the rig of the first avatar body to correspond to the second body cage; and animating the first avatar body by moving a skeleton of the updated rig and deforming a skinning of the updated rig.

In some implementations, the computer-implemented method further comprises moving the skeleton of the updated rig and deforming the skinning of the updated rig comprises reusing skin weights from the skinning of the first avatar body based on determining areas of skinning of the updated rig that are influenced by bones in the skeleton of the first avatar body.

In some implementations, transforming the first avatar body into the second avatar body comprises performing an interpolation between the first body cage and the second body cage.

In some implementations, transforming the first avatar body into the second avatar body comprises morphing a portion of the first avatar body that is less than an entirety of the first avatar body.

According to another aspect, a system is disclosed, comprising: a memory with instructions stored thereon; and a processing device, coupled to the memory, the processing device configured to access the memory, wherein the instructions when executed by the processing device cause the processing device to perform operations including: identifying a first avatar body having a first body cage; identifying a target avatar body having a target body cage; and performing an interpolation between the first body cage and the target body cage to obtain a second body cage corresponding to a second avatar body to provide a transformation of the first avatar body into the second avatar body.

Various implementations of the system are described herein.

In some implementations, performing the interpolation comprises performing the interpolation to generate the second body cage that completely matches the target body cage to provide a full transformation.

In some implementations performing the interpolation comprises transforming the first avatar body into the second avatar body that is a blend between the first avatar body and the target avatar body to provide a partial transformation.

In some implementations, performing the interpolation comprises morphing a portion of the first avatar body that is less than an entirety of the first avatar body.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF THE DRAWINGS

FIG. 1 is a diagram of an example system architecture that includes a 3D environment platform that can support 3D avatars with clothing fitted thereon, in accordance with some implementations.

FIG. 2 illustrates an example body cage, in accordance with some implementations.

FIG. 3 illustrates another example body cage, in accordance with some implementations.

FIG. 4 illustrates an example of portions of a body cage that are grouped into corresponding body parts, in accordance with some implementations.

FIG. 5 illustrates an example of a clothing layer deformed over a body cage, in accordance with some implementations.

FIG. 6 illustrates an example of an outer cage formed based on the clothing layer and portions of the body cage of FIG. 5, in accordance with some implementations.

FIG. 7 illustrates an example of an interpolation between two body cages to obtain a new body cage, in accordance with some implementations.

FIG. 8 illustrates an example of the generation of a new body cage, in accordance with some implementations.

FIG. 9 illustrates an example of the transformation of an avatar body during a virtual experience, in accordance with some implementations.

FIG. 10 illustrates another example of the transformation of an avatar body during a virtual experience, in accordance with some implementations.

FIG. 11 illustrates another example of the transformation of an avatar body during a virtual experience, in accordance with some implementations.

FIG. 12 illustrates an example of transformation of an avatar in a configuration environment, in accordance with some implementations.

FIG. 13 illustrates an example of layered clothing for an avatar body in a virtual experience, in accordance with some implementations.

FIGS. 14-17 illustrate examples of transformation and animation of an avatar, in accordance with some implementations.

FIG. 18 is a flowchart illustrating a computer-implemented method to change avatar bodies, in accordance with some implementations.

FIG. 19 is a flowchart illustrating another computer-implemented method to change three-dimensional (3D) avatar bodies, in accordance with some implementations.

FIG. 20 is a flowchart illustrating a computer-implemented method to perform skin morphing, in accordance with some implementations.

FIG. 21 is a flowchart illustrating a computer-implemented method to perform facial action coding system (FACS) pose morphing.

FIG. 22 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

The present disclosure describes techniques to dynamically change a visual aspect of a user's avatar (e.g., the visual appearance of an avatar associated with the user as the user participates in a virtual experience). For example, while participating in a virtual experience, the user can change the avatar from a humanoid avatar body to an animal (non-humanoid) avatar body or other different avatar body. The entire (original) avatar body can be changed or otherwise transformed in its entirety to the new (different) avatar body, or only regions/portions of the original avatar body can be selectively changed (e.g., just the head or other body part) while other regions/portions of the original avatar body remain unchanged.

The transformation from the original avatar body to a target avatar body can be a full transformation, in that the original (first) avatar body is completely transformed into the target avatar body that becomes the new (second) avatar body. The transformation can alternatively be a partial transformation, in that the new (second) avatar body is mixture or other type of blending that is in-between the original (first) avatar body and the target avatar body.

According to various implementations, the new avatar body can be obtained by performing an interpolation between a body cage of the original (first) avatar body and a body cage of the target avatar body, such that the resulting new avatar body has its own body cage that has been interpolated/generated from the body cages of the original avatar body and the target avatar body.

Dynamic editing/changing of an avatar body may be performed while the avatar has no clothing fitted thereon, and/or may be performed when the avatar body has one or more layers of clothing fitted thereon. When the avatar body is clothed, dynamically changing the avatar body (e.g., changing its shape) also results in a corresponding change to the layer(s) of clothing being worn by an avatar.

For example, the original avatar may be a humanoid avatar wearing a baseball cap over the head, thereby giving the baseball cap a rounded appearance. If the user changes the head of the humanoid avatar to an alien head (such as an alien avatar having a conehead), then the baseball cap can also be correspondingly and dynamically deformed so as to change from its original rounded appearance to a more pointed appearance that fits the conehead of the alien (target) avatar. Dynamically deforming the clothing (including accessories) of the avatar can also be based on cages, as is explained later below.

According to various implementations, the target avatar body and its clothing can be selected by the user during runtime while participating in a virtual experience. For example, the user can select a target avatar body by selecting (e.g., clicking on) another avatar in the virtual experience, by selecting the target avatar body from a library, by manipulating the original (current) avatar body directly (e.g., by changing its cage) without necessarily selecting a target avatar body in the virtual experience or from a library, and so forth. An adjustment tool, such as a slider bar, can be provided on a user interface to enable the user to control the amount of transformation between two avatar bodies.

In some implementations, the adjustment tool and/or some other transformation tool may be used to dynamically change/transform the current avatar body in a direct manner, without necessarily involving an interpolation between two avatar bodies. That is, and as an example, the user may use the transformation tool to change a shape of a head of the avatar from a humanoid head to a geometric head (e.g., block-shaped)—this transformation may be performed in some implementations by directly changing (e.g., moving or other manipulation of) the segments and vertices of the cage of the humanoid head using the transformation tool. This technique can be utilized without the requirement to have present or use a body cage for the geometric head as a reference (target) and without the requirement to perform interpolation between such reference body cage and the body cage of the humanoid head. Thus, this technique may be considered as a “free form” approach to independently changing the appearance of an avatar, wherein changes in the appearance are not relative to any other avatar.

Various techniques described herein to dynamically change avatar bodies (with or without clothing layered thereon) may be applied to avatars that are used in a virtual experience. Such virtual experiences are sometimes described herein in the context of an electronic game. It is understood that such implementations described in the context of electronic games are for purposes of convenience in providing examples and illustrations.

The techniques described herein can be used for other types of virtual experiences in a three-dimensional (3D) environment that may not necessarily involve an electronic game having one or more players represented by avatars. Examples of virtual experiences may include a virtual reality (VR) conference, a 3D session (e.g., an online lecture or other type of presentation involving 3D avatars), an augmented reality (AR) session, or in other types of 3D environments in which one or more users are represented in the 3D environment by one or more 3D avatars.

With layered clothing, an automated cage-to-cage fitting technique may be used for 3D avatars. The technique permits any body geometry to be fitted with any clothing geometry, including enabling layers of clothing to be fitted over underlying layer(s) of clothing, thereby providing customization without the limits imposed by pre-defined geometries, or requiring complex computations to make a clothing item compatible with arbitrary body shapes of avatars or other clothing items.

The cage-to-cage fitting is also performed using various techniques employed by a gaming platform or gaming software (or other virtual experience platform/software that operates to provide a 3D environment), without requiring avatar creators (also referred to as avatar body creators, or body creators) or clothing item creators to perform complex computations. The terms “clothing” or “piece of clothing” or other analogous terminology used herein are understood to include graphical representations of clothing and accessories, and any other item that can be placed on an avatar in relation to specific parts of an avatar cage.

At runtime during a game or other virtual experience session, a player/user accesses a body library to select a particular avatar body and accesses a clothing library to select pieces of clothing to place on the selected body. A 3D virtual environment platform that presents avatars implements the cage-to-cage fitting techniques to adjust (by suitable deformations, determined automatically) a piece of clothing to conform to the shape of the body, thereby automatically fitting the piece of clothing onto the body (and any intermediate layers, if worn by the avatar).

When the piece of clothing is fitted over the body and/or underlying piece of clothing, the techniques described herein may be performed to deform or otherwise fit the piece of clothing more precisely to the avatar, such as in terms of scale (e.g., proportionality), shape, etc. A user can further select an additional piece of clothing to fit over an underlying piece of clothing, with the additional piece of clothing being deformed to match the geometry of the underlying piece of clothing.

The implementations described herein are based on the concept of cages and meshes. A body mesh (or render mesh) is the actual visible geometry of an avatar. A body mesh includes graphical representations of body parts such as arms, legs, torso, head parts, etc. and can be of arbitrary shape, size, and geometric topology. Analogously, a clothing mesh (or render mesh) can be any arbitrary mesh that graphically represents a piece of clothing, such as a shirt, pants, hat, shoes, etc. or parts thereof.

In comparison, a cage represents an envelope of features points around the avatar body that is simpler than the body mesh and has weak correspondence to the corresponding vertices of the body mesh. As is explained in further detail later below, a cage may also be used to represent not only the set of feature points on an avatar body, but also a set of feature points on a piece of clothing.

In some implementations, there is a dynamic body-part modification mechanism implemented by extending a layered clothing system's layered clothing framework to permit use of user-specified cages to deform avatar body parts. This core functionality may be applied in at least two technologies. First, there may be a plugin to a studio application that enables users to change an avatar's overall body shape based on that of another avatar, such as by dialing/adjusting a slider that interpolates between the two body shapes. Second, there may be a virtual experience in which a player may incrementally update an avatar body by clicking on other avatar body parts in the virtual experience.

Some existing techniques to dynamically change an avatar may include Linear Blend Skinning (LBS), Facial Action Coding System (FACS), and Affine Skinning techniques. These technologies serve as the basis of current approaches including Skin Morphing and Facial Action Coding System (FACS) Pose Morphing.

In Linear Blend Skinning (LBS), the i^{th} deformed position p′ᵢ is computed in the vertex shader as

$${p}_{i}^{′} = {\sum }_{j = 0}^{4} ( {w}_{i , j} \cdot {M}_{j} \cdot {p}_{i} ) .$$

In this equation, the skin weight w_{i,j} and vertex bind position pᵢ are constant and cached on the GPU. If less than 4 bones are used, w_{i,j} may be 0. The 3×4 bone transform Mⱼ is computed on the CPU and copied to the GPU every frame:

$${M}_{j} = {B}_{j}^{- 1} \cdot {P}_{j} .$$

The inverse bind transform

$${B}_{j}^{- 1}$$

is a cached constant while the pose transform Pⱼ updates every frame. The global transforms Bⱼ and Pⱼ are computed from a hierarchy of local transforms LBⱼ and LPⱼ called a skeleton: Bⱼ=B_{j′}·LB, Pⱼ=P_{j′}·LBⱼ·LPⱼ where j′ is the index of the j^{th} node's parent, or root part. The skeleton hierarchy and transforms are provided by other engine systems like physics for bodies or FACS for dynamic heads. These are the various sources that are providing animation that may pose the avatar.

The FACS system provides LBS data for dynamic head meshes. The skin weights w, skeleton hierarchy j′ and local bind transforms LBⱼ come from the content delivery network (CDN) mesh data structure with the mesh and controls-to-joint-driver data, which is a mapping from FACS control values to joint positions and rotations for a given mesh. The local pose transforms LPⱼ are composed per-frame from the 3×3 rotation matrices R_{j,k} and the translation vectors T_{j,k}:LPⱼ=R_{j,k}|T_{j,k} where

$${R}_{j , k} = fromEuler ( {\sum }_{k = 0}^{n} ( {s}_{k}^{′} \cdot {r}_{j , k} ) ) and {T}_{j , k} = {\sum }_{k = 0}^{n} ( {s}_{k}^{′} \cdot {t}_{j , k} ) .$$

The Euler angles r_{j,k} and translation vector t_{j,k} also come from the mesh data structure ControlToJointDriver structure which defines the mapping for the mesh that converts FACS control values to skinned joint positions and rotations. The data structure may be an M×N matrix where M is the number of FACS data channels, and N is the number of joint transformation values. The matrix is used to transform the FACS controls into transform values, which drive the facial skeleton joints.

The rotations are interpolated in Euler coordinates, so R_{j,k} is rigid. The 17<=n<=50 shape weights s′ are computed as: s′=applyCorrectives(s,C) where the applyCorrectives function expands the 17 raw FACS pose weights s into up to 50 shape weights s′ based on CustomCorrections parameters C also from the ControlToJointDriver structure. For selected combinations of 2 or 3 raw FACS weights, the default linear average shape can be replaced with a custom shape built for that combination. This is used to improve artist control and deformation quality.

Previously, bind and pose transforms were rigid CoordinateFrame types. A rigid transform (also called a Euclidean transform) is a geometric transform of a Euclidean space that preserves the Euclidean distance between every pair of points. That was previously sufficient because every data model (DM) and FACS transform was rigid. Knowing this, rotations can be transposed when calculating their inverse. This can be a significant optimization when transform inversion is a hot spot, e.g. during physics updates. But for LBS, the only inversion Bⱼ⁻¹ is cached as a constant, so the technique does not significantly benefit from this optimization.

Approximating elastic skin is a common use case for LBS, but skin does not deform rigidly. Elastic deformations are ordinarily approximated with rigid bone transforms, which is natural when the deformations are driven by a rigid skeleton. But facial muscles are not rigid. Facial muscles can shear and scale non-uniformly, so there is no physical reason to limit the facial “bones” to rigid transforms. Because affine transforms are a superset of rigid transforms, the affine transforms can be used without changing existing rigs, while adding flexibility that can be leveraged in future rigs.

A dynamic head's weight maps divide the face into regions, providing the necessary degrees of freedom to hit the 17-50 poses. Its pose transforms articulate those regions in response to the 17 FACS controls. If the shape of a dynamic head is changed, and it is preferred these poses to continue looking good, the bone transforms may involve a change. If the shape changes do not change the semantic meaning of vertices, i.e. a cheek vertex does not become a nose vertex etc., the skin weights can often be reused.

If skin weights are reused, which areas of the surfaces are influenced by each bone can be expressed. It may also be noticed that the pose transforms animate in directions and amounts linked to the surface shape in the region the poses are influencing. This influence includes not only its own weights, but also the weights of any descendant bones in the skeletal hierarchy. For example, the influence of the head joint includes the influence of the lip joints, etc., because when the neck turns, the lip joints turn with the neck. Also, because a vertex influences the shape of the connected faces, these influence sets are expanded by one edge. Unlike LBS, these influence weights sets are not normalized.

Skin morphing may include, for each bone, computing the 3×4 affine transform that optimally fits the deformation of its influenced point cloud using some linear algebra. This correction is applied to the bone transform in the skinning computation:

$${p}_{i}^{′} = {\sum }_{j = 0}^{4} ( {w}_{i , j} \cdot {D}_{j} \cdot {M}_{j} \cdot {p}_{i} ) ,$$

where the correction is the matrix Mⱼ. This approach may work, but the techniques are not designed to change the skinning pipeline, techniques are designed to update the rig. Thus, Dⱼ is bubbled up through the skeleton computation and Dⱼ is incorporated into a new local bind transform LB′ⱼ which generates the same result: LB′ⱼ=Bⱼ⁻¹·Dⱼ·B_{j′}·LBⱼ. For example, this may be a simple algebraic manipulation to solve for a new local bind transform LB′ⱼ that produces the same result as the previous formulation, but with the Mⱼ term removed.

Note that LB′ⱼ is no longer a rigid transformation after this, so for any data-model bone, the result can be orthonormalized, but for dynamic heads, the full affine transform is retained, and the result is improved significantly. This makes the result dependent on the affine skinning change discussed above.

With respect to FACS pose morphing, the present FACS rigs contain many poses, and each pose includes sets of local transforms Pⱼ for each joint in the head rig. The skin morphing technique updates their bind transforms LB′ⱼ, which changes the parent space of these local pose transforms.

The affine correction transform Dⱼ changes the translation of the resulting Mⱼ transform, both its direction and magnitude, but the affine correction transform Dⱼ does not change the rotation of the resulting Mⱼ transform. To improve the result even further, the per-pose, per-joint rotations r_{j,k} also are to be updated. In that process further fine-tuning the per-pose, per-joint translations t_{j,k} can occur as well.

In some implementations, fine-tuning may be performed one pose at a time. First, the original LBS deformed mesh pose is computed from the original head shape. For each joint in the pose, its skin-weighted points are projected to the nearest points on the posed mesh, providing a new set of points. These points represent the locations on the original mesh nearest to the “destinations” of that joint in that pose. The same 3×4 affine fit function can then be reused to calculate how these points have transformed between the original shape and the modified shape.

In some implementations, the rigid component of that transform is extracted and to fine-tune that pose-joint's final translation and rotation. In order to minimize the changes to the Euler interpolation, an appropriate change is made to the Euler angles that match that rotation. For example, Euler rotations can express the same rotation matrix in an infinite number of ways so appropriate techniques are used to change the original angles as little as possible. These angles are calculated by decomposing the rotation matrix and inserting the corrections incrementally. R=R_{z}_{₁}R_{y}_{₁}Rₓ_{₁}, then R′=R_{z}_{₂}R_{z}_{₁}R_{y}_{₂}R_{y}_{₁}Rₓ_{₂}Rₓ_{₁}, then x′=x₁+x₂, y′=y₁+y₂, and z′=z₁+z₂.

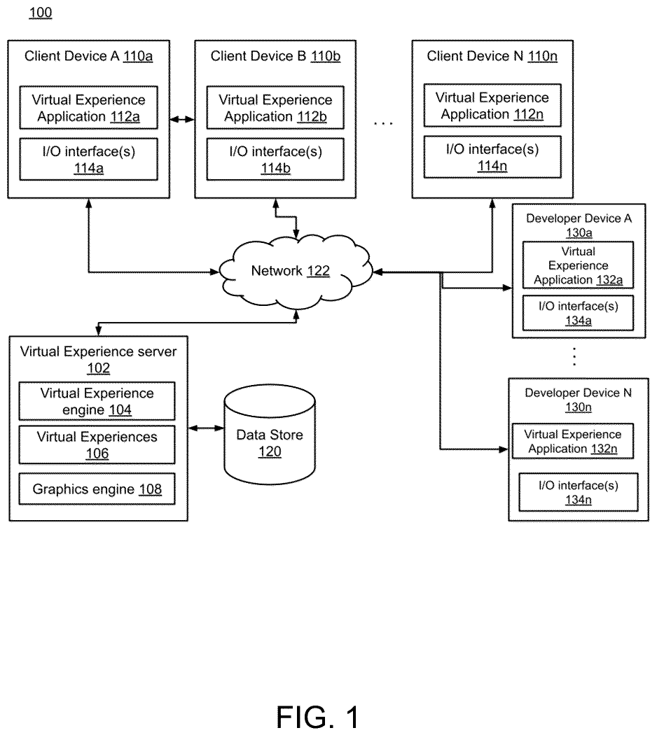

### FIG. 1—System Architecture

FIG. 1 is a diagram of an example system architecture that includes a 3D environment platform that can support 3D avatars with clothing fitted thereon, in accordance with some implementations. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client devices(s) 110 and developer device(s) 130 may refer to the same or same type of device.

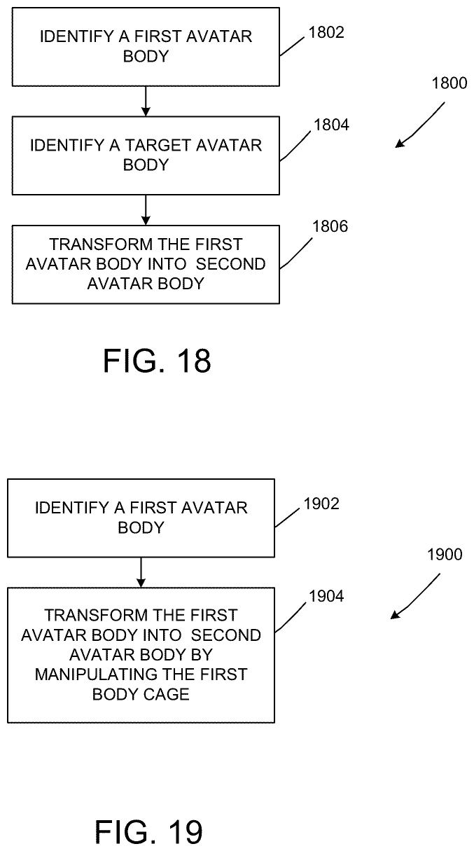

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 and/or virtual experience engine 104 may perform one or more of the operations described below in connection with the flowchart shown in FIGS. 18-21. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may also include multiple storage components (e.g., multiple drives or multiple databases) that may also span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants, with appropriate permissions from the players and in compliance with applicable regulations.

In some implementations, the chat transcripts are generated via virtual experience application 112 and/or virtual experience application 132 or and are stored in data store 120. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 120.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. Other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be a virtual gaming server. For example, the gaming server may provide single-player or multiplayer games to a community of users that may access as “system” herein) includes online virtual experience server 102, data store 120, client or interact with virtual experiences using client devices 110 via network 122. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 106 may be collectively referred to as a “world” or “virtual experience world” or “gaming world” or “virtual world” or “universe” herein. An example of a world may be a 3D world of a virtual experience 106. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters, decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine/application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 exceeds a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For instance, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc.

One or more characters (also referred to as an “avatar” or “model” herein) may be associated with a user where the user may control the character to facilitate a user's interaction with the virtual experience 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g., shirts, pants, etc. the online virtual experience platform may provide users access to simplified 3D virtual object models that are represented by a mesh of a low polygon count, e.g., between about 20 and about 30 polygons.

In some implementations, the user may also control the scale (e.g., height, width, or depth) of a character or the scale of components of a character. In some implementations, the user may control the proportions of a character (e.g., blocky, anatomical, etc.). It may be noted that is some implementations, a character may not include a character virtual experience object (e.g., body parts, etc.) but the user may control the character (without the character virtual experience object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience server 102. In some implementations, creating, modifying, or customizing characters, other virtual experience objects, virtual experiences 106, or virtual experience environments may be performed by a user using a I/O interface (e.g., developer interface) and with or without scripting (or with or without an application programming interface (API)). It may be noted that for purposes of illustration, characters are described as having a humanoid form. It may further be noted that characters may have any form such as a vehicle, animal, inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character (e.g., avatar) can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 130 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or engage in virtual experiences 106 hosted by online virtual experience server 102). As such, the virtual experience application may be provided to the developer device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through suitable application programming interfaces (APIs), and thus is not limited to use in websites.

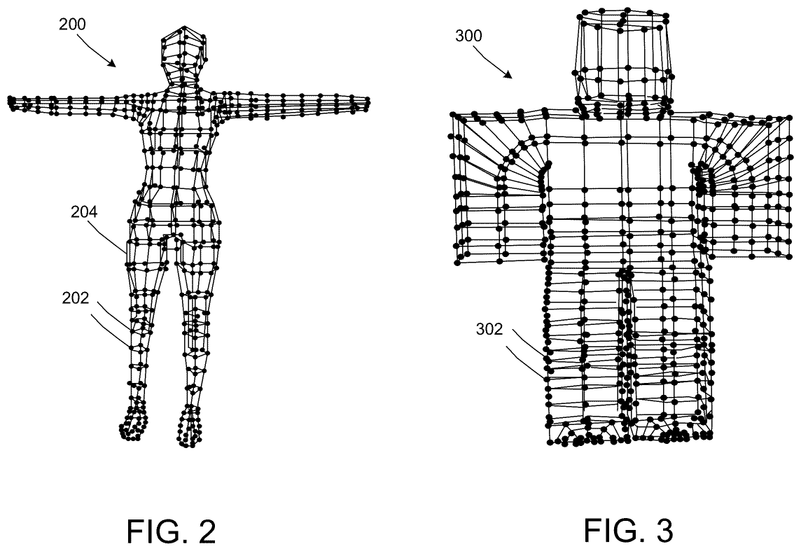

### FIG. 2—Example Body Cage

FIG. 2 illustrates an example body cage 200, in accordance with some implementations. The body cage 200 in the example of FIG. 2 is an outer cage that envelopes or is superimposed on the external surface/contours of a humanoid body shape that acts as a mannequin. The underlying humanoid body shape (mannequin, not shown), which is enveloped by the body cage 200, may be represented by or comprised of a body mesh that includes multiple polygons and their vertices. The polygons of the body mesh (as well as those of a clothing mesh) may be triangles, with the surface area of each triangle providing a face or mesh face.

The body cage 200 comprises a plurality of feature points 202 that define or otherwise identify or correspond to the shape of the mannequin. In some implementations, the feature points 202 are formed by the vertices of segments/sides 204 of multiple polygons (or other geometric shape) on the mannequin. According to various implementations (and although not illustrated as such in FIG. 2), the polygons may be triangles, with the surface area of each triangle providing a face or cage face. In some implementations, the feature points 202 may be discrete points, without necessarily being formed by vertices of any polygons.

The body cage 200 of FIG. 2 is an example of a low-resolution body cage with 642 feature points (or some other number of feature points) for a humanoid body geometry that lacks fingers. Other examples may use a body cage with 475 feature points (or some other number of feature points). A body cage of a humanoid geometry that includes fingers may have 1164 feature points (or some other number of feature points), for example. Higher resolution body cages may include 2716 feature points (or some other number of feature points). These numbers (and ranges thereof) of feature points are just some examples—the number of feature points may vary from one implementation to another depending on factors such as preferred resolution, processing capability of the 3D platform, user preferences, size/shape of the mannequin, etc.

### FIG. 3—Example Body Cage

FIG. 3 illustrates another example body cage 300, in accordance with some implementations. Cages may be provided for any arbitrary avatar body shape or clothing shape. The body cage 300 in the example of FIG. 3 is an outer cage that envelopes or is superimposed on the external surface/contours of a body mesh of a generic gaming avatar body shape.

Compared to the body cage 200 of FIG. 2, the body cage 300 of FIG. 3 may have the same number of feature points. In some implementations, the body cage 300 may have a number of feature points that is different in number compared to the body cage 200, such as a fewer or greater number of feature points 302 as a consequence of a different (simpler or more complex) geometric shape of the gaming avatar and/or based on other factor(s). Thus, the number of feature points from one body cage to another may be different and selected based on different body shapes or other body properties.

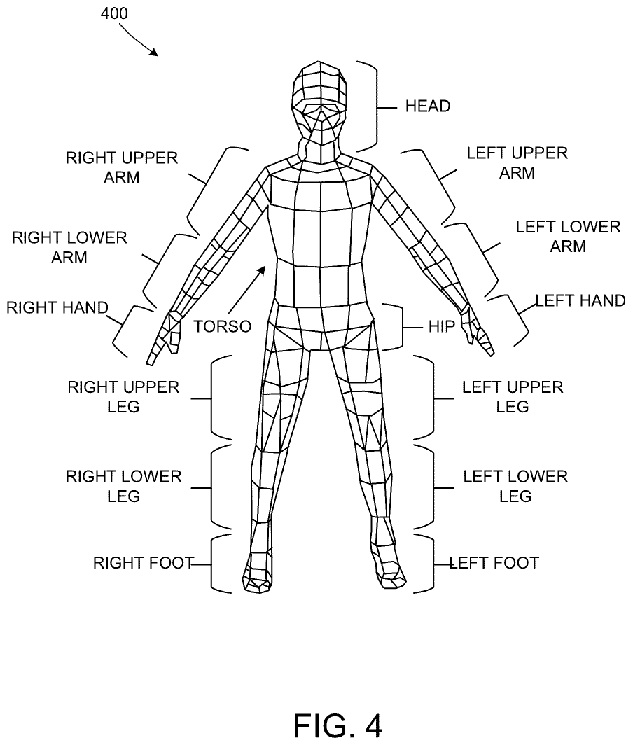

### FIG. 4—Portions of Body Cage

FIG. 4 illustrates an example of portions of a body cage 400 that are grouped into corresponding body parts, in accordance with some implementations.

In some implementations, for bandwidth and performance/efficiency purposes or other reason(s), the number of feature points of a cage may be reduced to a smaller number than those provided above, such as 475 feature points (or some other number of feature points). Furthermore, in some implementations, the feature points (vertices) in a body cage may be arranged into a plurality of groups (e.g., 15 groups) that each represent a portion of the body shape.

More particularly, the 15 body parts illustrated in FIG. 4 are (for a humanoid mannequin): head, torso, hip, right foot, left foot, left lower leg, right lower leg, left upper leg, right upper leg, left hand, right hand, left lower arm, right lower arm, left upper arm, and right upper arm. The number of parts in any body shape may be greater or fewer than the 15 body parts illustrated. For example, a “one-armed” avatar character may have 12 (as opposed to 15) body parts, due to the omission of a hand, lower arm, and upper arm. Furthermore, other body shapes may involve a fewer or greater numbers of body parts, depending on factors such as body geometry, preferred resolution, processing capability, type of avatar character (e.g., animal, alien, monster, and so forth), etc.

Each of the 15 groups/parts in FIG. 4 includes the feature points that define that part of the avatar body. Such group(s) of feature points may in turn be mapped to a corresponding piece of clothing. For example, the feature points in the body cage 400 that define the left/right lower arms, the left/right upper arms, and the torso may be used as an outer cage to be mapped with an inner cage of a jacket, in that a graphical representation of jacket is made up of graphical meshes that render left/right arms and a torso of the jacket that logically and correspondingly fit over left/right arms and a torso of an avatar body.

Moreover, this separation into multiple groups (such as illustrated in FIG. 4) enables customized fitting of a piece of clothing over atypical body shapes. For instance, a 3D avatar may be in the form of a “one-armed” avatar character that is missing the left arm. Thus, the body cage for that 3D avatar lacks the groups of feature points corresponding to the left hand, left lower arm, and left upper arm.

When a jacket is subsequently selected for fitting over that 3D avatar, the right lower arm, right upper arm, and torso of the jacket may be deformed to fit over the corresponding right lower arm, right upper arm, and torso of the 3D avatar (body mannequin), and the left lower arm and the left upper arm of the jacket are not deformed (e.g., remains rigid in its original form from its parent space) since there is no left arm cage in the body mannequin to deform against.

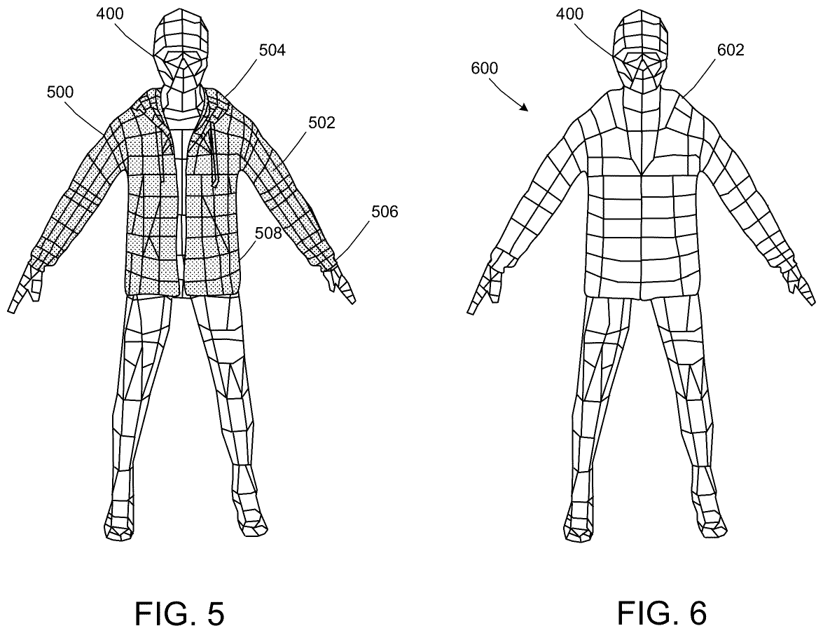

### FIG. 5—Clothing Layer Deformed Over Body Cage

FIG. 5 illustrates an example of a clothing layer 500 deformed over a body cage (such as the body cage 400 illustrated in FIG. 4), in accordance with some implementations. The clothing layer 500 is a graphical representation of a jacket (illustrated in gray shading in FIG. 5) having parts that may be generated/rendered using a polygon mesh 502 (e.g., a clothing mesh) that is comprised of a collection of vertices, edges, and faces (which may be triangle faces or other polygon faces).

The clothing layer 500 includes an inner cage (not illustrated in FIG. 5) having feature points that correspond to the feature points of the body cage 400. Specifically, the feature points of the inner cage of the clothing layer 500 are mapped to the feature points of the body cage 400 that make up the left and right lower arms, the left and right upper arms, and the torso.

In some implementations, this mapping includes mapping the feature points of the inner cage of the clothing layer 500 directly onto the coordinate locations of the corresponding feature points of the arms and torso of the body cage 400. Such mapping may involve a 1:1 correspondence when both cages have same number of feature points, and the mapping may be n:1 or 1:n (wherein n is an integer greater than 1), in which case multiple feature points in one cage may be mapped to the same feature point of the other cage (or some feature points may be unmapped).

The clothing layer 500 further includes an outer cage having feature points that are spaced apart from and linked to the corresponding feature points of its inner cage of the clothing layer 500. The feature points of the outer cage of the clothing layer 500 define or are otherwise located along the external surface contours/geometry of the jacket, so as to define features such as a hood 504, cuffs 506, straight-cut torso 508, etc. of the jacket.

According to various implementations, the spatial distances (e.g., a spatial distance between a feature point of the inner cage of the clothing layer 500 and a corresponding feature point of the outer cage of the clothing layer 500) are kept constant during the course of fitting the clothing layer 500 over an outer cage of an existing layer (or avatar body). In this manner, the feature points of the inner cage of the clothing layer 500 may be mapped to the feature points of the body cage 400, so as to fit the inside of the jacket over the avatar's torso and arms.

Then, with the distances between the feature points of the inner cage of the clothing layer 500 and the corresponding feature points of the outer cage of the clothing layer 500 being kept constant, the outer contours of the jacket may also be deformed so as to match the shape of the avatar body, thereby resulting in at least partial preservation of the visual appearance (graphical representation) of the hood, cuffs, straight-cut torso and other surface features of the jacket while at the same time matching the shape of the avatar body as illustrated in FIG. 5. In this manner, the clothing layer 500 be deformed in any appropriate manner so as to fit any arbitrary shape/size of an avatar body (body cage), such as tall, short, slim, muscular, humanoid, animal, alien, etc.

### FIG. 6—Example Outer Cage

FIG. 6 illustrates an example of the clothing layer and portions of the body cage 400 of FIG. 5 being used to form an outer cage 600, in accordance with some implementations. In some implementations, additional clothing layers over other clothing layer(s) may be placed (e.g., in response to user selection). More specifically, the feature points of the outer cage of the clothing layer 500 of FIG. 5 are now combined with the feature points of the body cage 400, so as to result in a composite outer cage 600 that is made up of feature points of exposed portions of the body cage 400 and feature points along the exterior surface of the jacket.

For example, the exposed outer surfaces 602 of the jacket (formed by the body, hood, and sleeves of the jacket) provide a set of feature points and the exposed legs, hands, head, and part of the chest of the body that are not covered by the jacket provide another set of feature points, and these two sets of feature points (combined) provide the feature points of the outer cage 600.

The feature points of the outer cage 600 in FIG. 6, which correspond to and define the outer surface/shape of the jacket, may be the same feature points of the outer cage of the clothing layer 500 of FIG. 5. In some implementations, different and/or additional and/or fewer feature points may be used for the region of the jacket in the outer cage 600 in FIG. 6, as compared to the feature points for the outer cage of the jacket (clothing layer 500) of FIG. 5.

For instance, additional feature points may be computed for the outer cage 600 encompassed by the jacket area (as compared to the outer cage of the clothing layer 500 of FIG. 5), if higher resolution or more precise fitting is preferred for the next layer of clothing above the outer cage 600. Analogously, feature points may be computed for the outer cage 600 encompassed by the jacket area (as compared to the outer cage of the clothing layer 500), if a lower resolution or less precise fitting is preferred for the next layer of clothing above the outer cage 600 and/or due to other considerations such as processing/bandwidth efficiency improvements provided by using fewer feature points when possible.

In operation, if the user provides input to fit an additional clothing layer (such as an overcoat or other article of clothing) over the jacket (clothing layer 500) and/or over other parts of the avatar body, then the feature points of the inner cage of such additional clothing layer are mapped to the corresponding feature points of the outer cage 600. Deformation may thus be performed in a manner similar to that described with respect to FIG. 5. According to some implementations, radial basis function (RBF) techniques and/or other analogous interpolation techniques may be used to deform a piece of clothing that is fitted over an underlying piece of clothing or body part of an avatar.

Thus, in accordance with the examples of FIGS. 5 and 6 for layering clothing, a first layer of clothing (clothing layer 500) is wrapped around the body by matching the feature points of the “outer cage” (body cage 400) of the avatar body with the feature points of the “inner cage” of the first layer of clothing. This matching may be done in the UV space (where UV refers to a coordinate system) of the cages, so as not to have to rely on the number of feature points matching exactly between the inner and outer cages.

For example, the feature points may be vertices with both position and texture space coordinates. Texture space coordinates are usually expressed in a range [0,1] each for U, V coordinates. The texture space may be thought of as an “unwrapped” normalized coordinate space for the vertices. By performing the correspondence of the two sets of vertices in the UV space and not using their positions, vertex-to-vertex correspondence may be performed in the normalized space there by removing the hard obligation of exact vertex to vertex index mapping.

In the techniques for layering clothing, each avatar body and clothing item is thus associated with an “inner cage” and an “outer cage.” In the case of the avatar body, the inner cage represents a default “mannequin” (and different mannequins may be provided for different avatar body shapes) and the “outer cage” of the avatar body represents the envelope around the shape of the avatar body. For the clothing items, the “inner cage” represents the inner envelope that is used to define how the clothing item wraps around an underlying body (or around a body with prior clothing layers already fitted on it), and the “outer cage” represents the way that the next layer of clothing is wrapped around this particular clothing item when worn on the avatar body.

According to various implementations, the various cages described herein may be invisible during runtime. For example, while participating in a virtual experience, including traversing an avatar through a virtual 3D environment of a virtual experience, placing clothing onto an avatar body, wearing the clothing, animating the avatar, etc., the vertices and segments of the cage(s) may not be visible to the user and other users/viewers of the 3D environment. Also, the avatar and its deformed clothing are presented during runtime so as to appear cage-less, such that only the visual meshes of deformed clothing, skins, avatar body parts, etc. are visible to the user(s)—in reality, one or more cages may be present on the avatar for purposes described herein to deform clothing, to envelope avatar body parts and clothing items, to change an avatar body, etc., but not visible to the user(s) during runtime. The cages may be made visible to a user (e.g., such as via a view/edit cages command, during a configuration phase, etc.), so that the user can view and manipulate the cages if necessary for changing an avatar body as described herein, for creating a cage, or for other purposes.

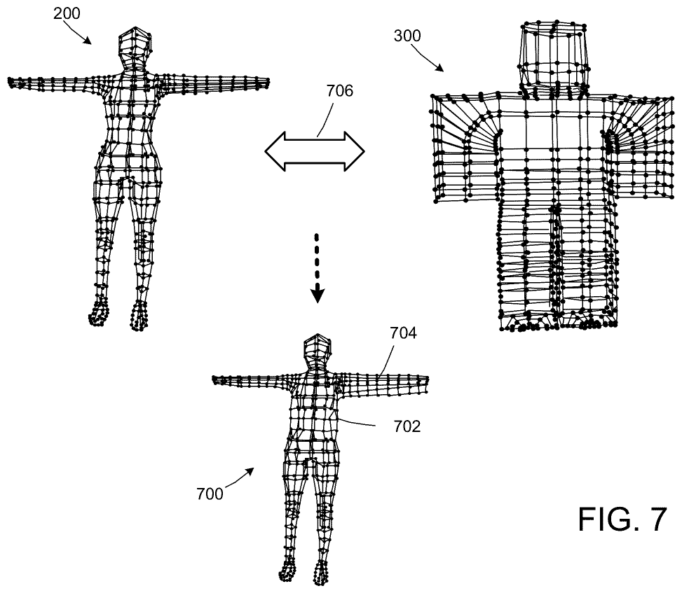

### FIG. 7—Interpolation Between Two Body Cages

FIG. 7 illustrates an example of an interpolation between two body cages to obtain a new body cage 700, in accordance with some implementations. More specifically, the example interpolation of FIG. 7 may be performed in a situation wherein the user has a current avatar body, and a user wishes to change/transform that current avatar body to some other (target) avatar body that is present in the virtual experience, in a library, etc. The interpolation and corresponding change of the current avatar body may be performed at runtime while the avatar is participating in a virtual experience, during a session in a studio or other configuration environment where the user can create and edit graphical objects, etc.

In the example of FIG. 7 and purely for purposes of illustration and explanation, the user's current avatar body may be a humanoid body having the body cage 200 of FIG. 2, and the user may wish to transform the current avatar body (or some portion thereof) to a target avatar body. The target avatar body selected by the user in the example of FIG. 7 may be the geometric avatar body having the body cage 300 of FIG. 3.

The new avatar body is illustrated in FIG. 7 as having a body cage 700. The new avatar body can be a full transformation from one or more parts of the original avatar body into one or more parts of the target avatar body. FIG. 7 illustrates both a full transformation and a partial transformation from one or more parts of the original avatar body into one or more parts of the target avatar body.

As an example of a full transformation, the shape of a torso 702 of the new avatar body has been transformed so as to fully match the rectangular shape of the torso of the target avatar (having the body cage 300)—the curved/tapered torso of the original avatar body (having the body cage 200) is no longer present in the new avatar body and has been fully morphed or otherwise transformed into the rectangular torso 702.

As an example of a partial transformation, the shape of an arm 704 of the new avatar body is a blend/mixture that is in-between the curved/tapered arm of the original avatar body (having the body cage 200) and the rectangular arm of the target avatar body (having the body cage 300). For instance, the arm 704 now has a more rectangular shape like the arm of the body cage 300 but still preserves some curvature and tapering of the arm of the body cage 200.

Thus, a full body transformation may be a body transformation where all body parts are fully transformed, and a partial body transformation may be a body transformation where one or more body parts are partially transformed or not transformed.

The body cage 700 of the new avatar body also represents a partial transformation in that not every part of the entire avatar body is morphed. For example, only the torso 702 and one arm 704 have undergone transformations, while the shape of the other parts (e.g., the head, the other arm, the legs, etc.) of the new avatar body are unchanged relative to the original avatar body. In various implementations, different parts of an avatar body may undergo partial or full transformation while other parts do not undergo any transformation. In some implementations, the entire avatar body may undergo partial or full transformation. In some implementations, morphing a portion of the first avatar body that is less than the entirety of the first avatar body comprises morphing the portion of the first avatar body to perform a partial transformation of the portion of the first avatar body.

The new avatar body (having the body cage 700) may be of the same or different size than either or both the original avatar body (having the body cage 200) and the target avatar body (having the body cage 300). In the example of FIG. 7, the new avatar body (having the body cage 700) is scaled so as to be smaller in size that both the original avatar body and the target avatar body.

To obtain the new avatar body (having the body cage 700), one or more interpolation operations 706 may be performed in some implementations. For instance, a linear or non-linear interpolation can be performed between the body cage 200 and the body cage 300. The interpolation can be performed between the values/coordinates corresponding to vertices or segments of the two body cages (body cage 200 and body cage 300), so as to obtain the resultant vertices/segments of the new body cage 700.

Alternatively, or additionally, at least some of the values/coordinates of the vertices/segments of the new body cage 700 can be computed/generated as new values that have not been interpolated from other value(s). This may be performed, for example, where a new vertex/segment of the new body cage 700 is to be created at a particular region of the avatar body, and there are no nearby vertices/segments of the two body cages 200 and 300 that can form the basis for an interpolation.

The example of FIG. 7 corresponds to implementations wherein a new avatar body (having a new body cage) has been generated based upon or relative to two other avatar bodies (having respective body cages). In some implementations, the new avatar body can be generated in a freer form manner that is not necessarily based on an existing target avatar body as a reference.

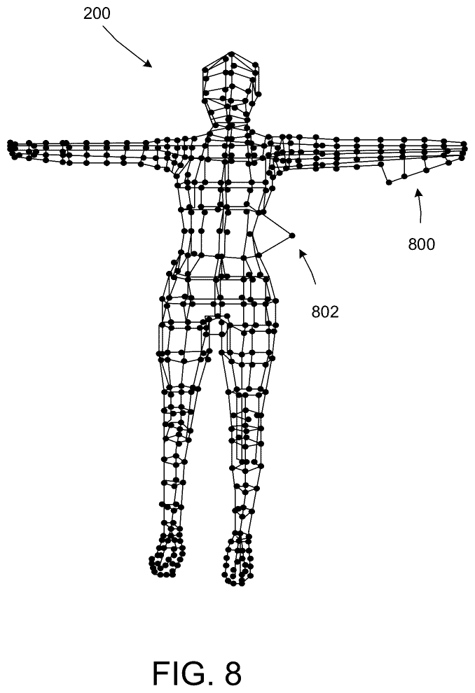

### FIG. 8—Generation of New Body Cage

FIG. 8 illustrates an example of such a generation of a new body cage 800, in accordance with some implementations. Purely for purposes of illustration and explanation, the user's current avatar body may be a humanoid body having the body cage 200 of FIG. 2, and the user may wish to transform the current avatar body (or some portion thereof) to a target avatar body.

To perform this transformation, the user may manipulate the vertices and/or segments of the body cage 200, using a transformation tool. For instance, a user may click and drag on vertices or segments of the arm to a new position, such as illustrated at 800. The user may click and drag on a vertex or segments of the torso to a new position, such as illustrated at 802. Rather than clicking and dragging existing vertices/segments, the user may also use the transformation tool to delete or add vertices/segments to a cage, draw/redraw portions of the cage, etc. during the process of generating the new avatar body.

With regards to cages and as previously described above with respect to FIGS. 2-6, there is an inter-relationship and dependency between multiple cages. For example, the body cage envelopes (completely encloses) the avatar body (including the body mesh), the inner cage of a first clothing item is mapped to the body cage, an outer cage envelopes the first clothing item (including its clothing mesh), an inner cage of a second clothing item is mapped to the outer cage of the first clothing item, an outer cage envelopes the second clothing item (including its clothing mesh), etc.

In view of such inter-relationships and dependencies, the manipulation or other change/transformation of at least one cage causes an automatic and corresponding change/transformation of one or more other cage(s), in some implementations. For example, if the body cage of the current avatar body is changed (such as illustrated in FIGS. 7 and 8) so as to change the shape of the avatar body, the corresponding cage(s) of one or more overlying clothing items are also automatically changed/updated, if the avatar body is wearing clothes, so as to deform/fit the clothing items in a dynamic manner to match the changed shape of the avatar body. The changes in the cage(s) in turn cause an appropriate change to the mesh, skinning, and other visual aspect of the avatar body and/or its clothes.

In other examples, manipulating a cage of a clothing item can be performed alternatively or additionally to changing a body cage, for purposes of changing the shape or other appearance of an avatar. Using the example previously described above pertaining to a current humanoid avatar wearing a round baseball cap and a target alien having a conehead, the user can operate a transformation tool to reshape the outer cage of the baseball cap from being rounded to being conical. This reshaping of the outer cage then correspondingly changes the visual appearance of the baseball cap from being rounded to being conical, and also changes the inner cage of the baseball cap and the underlying body cage of the head of the humanoid avatar body, so that the new avatar body now has a conehead.

According to various implementations, the morphing or other transformation of an avatar body (including its clothing) may be performed at runtime during a virtual experience. In such implementations, the cages may not necessarily be viewable to the user while participating in the virtual experience. Also, the user can select target avatars or other target graphical objects in the virtual experience, and a virtual experience engine or other related component(s) at the client side or server side can perform the appropriate cage manipulations (such as illustrated above with respect to FIG. 6) in a manner transparent to the user, such as via a background process. Thus, the user is seamlessly able to view the changed/changing visual appearance of the avatar body during the virtual experience, without actually viewing the cages themselves being manipulated.

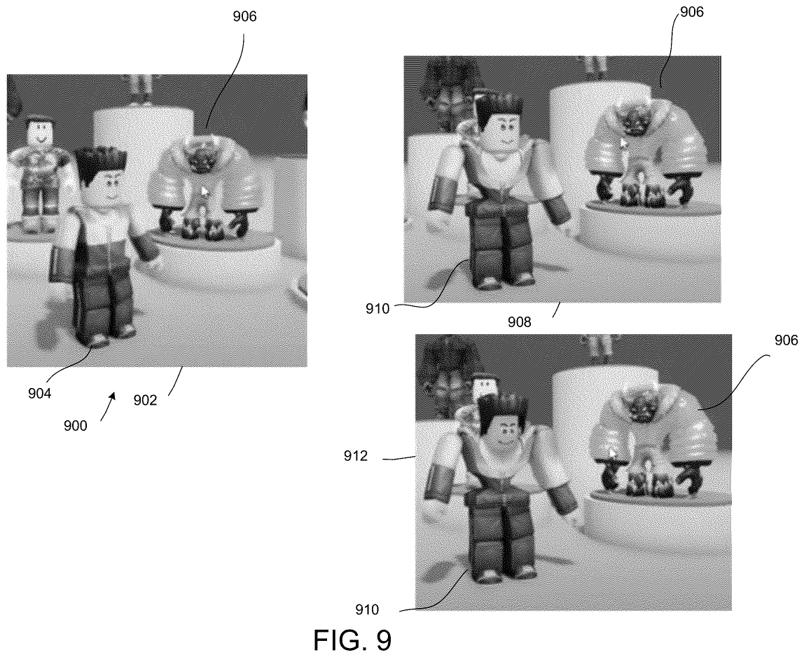

### FIG. 9—Transformation of Avatar Body During Virtual Experience

FIG. 9 illustrates an example of the transformation of an avatar body while the avatar participates in a virtual experience 900, in accordance with some implementations, such as explained above. In the virtual experience 900 at 902, a current avatar 904 of the user is a humanoid having generally geometric/rectangular shapes for its various body parts (e.g., head, arms, legs, torso, etc.). The user has selected (e.g., via clicking with a mouse cursor or via some other input tool) another avatar in the virtual experience 900 as a target avatar 906.

If the user selects the target avatar 906, a transformation of the current/original avatar 904 to a new (changed/changing) avatar 910 occurs at 908. At 908 and as compared to the original avatar 904, the new avatar 910 has a larger left arm, a tapered waist, hunched shoulders, etc. that resemble the corresponding body parts of the target avatar 906. At 912, further morphing is performed, such that the new avatar 910 is further modified to more closely match the target avatar 906 with a drooping head.

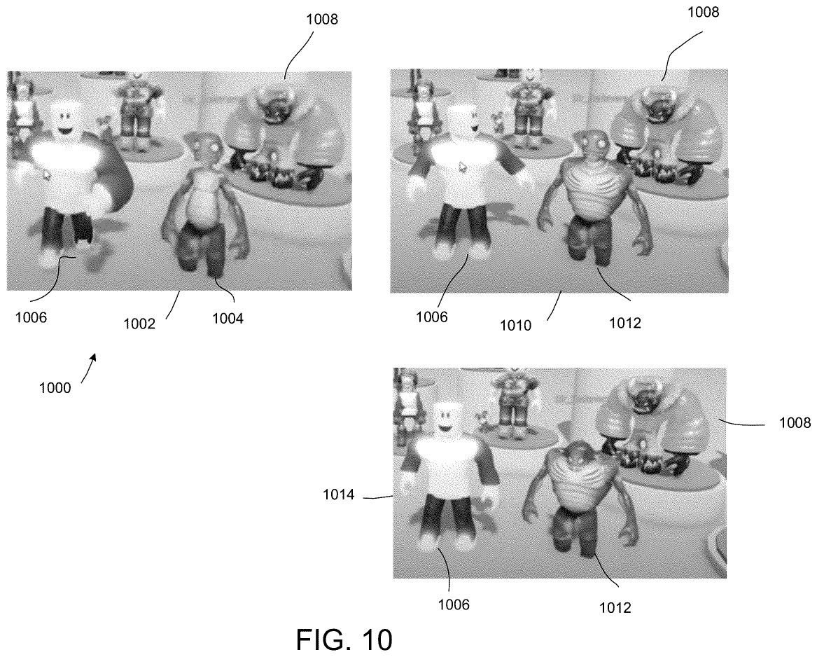

### FIG. 10—Transformation of Avatar Body During Virtual Experience

FIG. 10 illustrates another example of the transformation of an avatar body while the avatar participates in a virtual experience 1000, in accordance with some implementations. Specifically, FIG. 10 illustrates that the user may select multiple avatars as targets for morphing a current avatar body for an avatar. In the virtual experience 1000 at 1002, the user's current avatar 1004 has an alien body with a slim build/shape. A first target avatar 1006 is a humanoid avatar and has a muscular torso shape. A second target avatar 1008 is a monster having a drooping monster head with horns.

At 1010, the user has selected the first target avatar 1006, and so the original avatar 1004 has transformed into a new avatar 1012 that has a muscular torso like the first target avatar 1006. At 1014, the user has selected the second target avatar 1008, and so the new avatar 1012 continues transformation/morphing so as to have a drooping monster head and is shorter in height, like the second target avatar 1008.

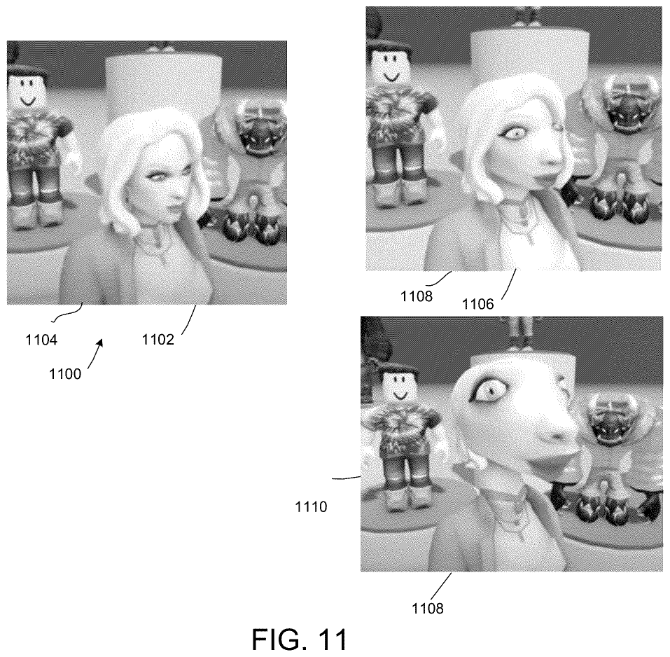

### FIG. 11—Transformation of Avatar Body During Virtual Experience

FIG. 11 illustrates another example of the transformation of an avatar body while the avatar participates in a virtual experience 1100, in accordance with some implementations. As previously explained, a portion of an avatar body can be changed (rather than changing the entire avatar body), and then corresponding changes can be made to clothing, skinning, accessories, etc. associated with the changed portion of the avatar body.

At 1102 in the virtual experience 1100, the user's current avatar 1104 has a humanoid head, with a nose, hair, lips and lipstick, eyes and eyelashes, etc. At 1106, the user has selected the head of another avatar in the virtual experience 1100, and so the head of the current avatar 1104 begins to morph from the humanoid head to a different head shape (e.g., animal-like) for a new avatar 1108. This morphing also affects the appearance (e.g., shape and size) of the nose, lips, eyes, etc.

At 1110, the head of the new avatar 1108 continues to further morph into an animal head. Accordingly, there are more pronounced animal-like appearances for the head, hair, nose, lips, eyes, etc. in the new avatar 1108.

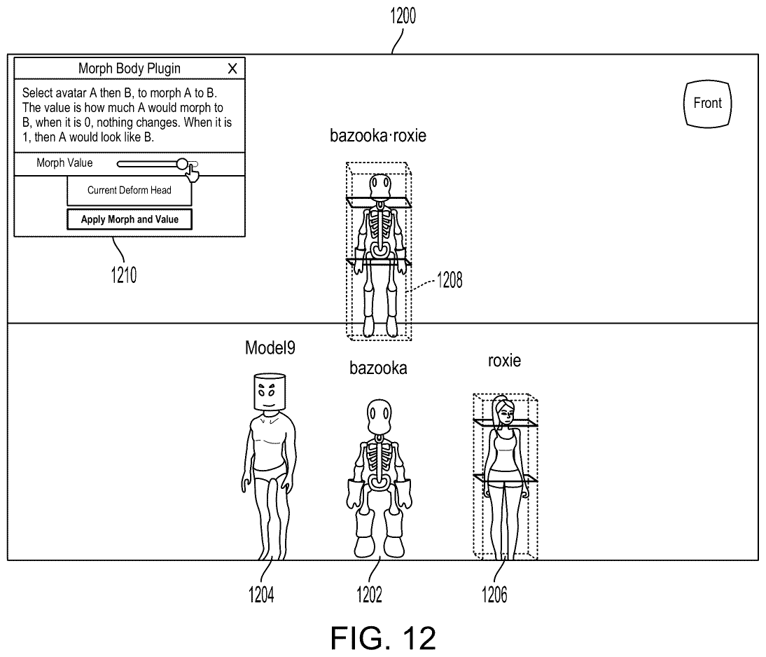

### FIG. 12—Transformation of Avatar in Configuration Environment

FIG. 12 illustrates an example of transformation of an avatar in a configuration environment 1200, in accordance with some implementations. The configuration environment 1200 may be a studio or other type of environment, wherein the user can configure avatars outside of the runtime environment of a virtual experience.

As such, the configuration environment 1200 may be an ancillary feature that is tied to a virtual experience but not within the virtual experience itself. Alternatively, or additionally, the configuration environment can be decoupled from any particular virtual experience, but its output (including avatars and other graphical objects) can be used and applied to the virtual experience.

In the configuration environment 1200, there are multiple models of avatars that are available: the user's avatar 1202 (bazooka), a first target avatar 1204 (Model9), and a second target avatar 1206 (roxie). The user's avatar 1202 in this example has an avatar body that is shaped like a stocky alien and is skeleton-like in form.

The user has selected the target avatar 1206 as the target avatar. Accordingly, the user's avatar 1202 is transformed into a new avatar 1208 that is rendered in the configuration environment 1200. The new avatar 1208, while retaining some of the skeletal-like features of the original avatar 1202, now has a more humanoid shape that corresponds to the target avatar 1206 and is taller.

According to various implementations, the configuration environment 1200 may be provided with an adjustment tool and/or other type of transformation tool 1210. For example, transformation tool 1210 indicates that the transformation tool 1210 corresponds to a “Morph Body Plugin” and provides the instructions “Select avatar A then B, to morph A to B. The value is how much A would morph to B, when it is 0, nothing changes. When it is 1, then A would look like B.”

In the example of FIG. 12, the transformation tool 1210 includes a slider bar or other analogous tool (“Morph Value”) to control the amount of morphing (e.g., a morphing value) between a current avatar and a target avatar. There may be a button indicating “Current Deform Head” and a button indicating “Apply Morph and Value.”

Thus, the new avatar can have a minimum morphing value of 0 (e.g., no change from the current avatar), a maximum morphing value (e.g., the new avatar is a complete transformation into the target avatar), and any other morphing value between the minimum and maximum morphing values (e.g., the new avatar is a blend between the original avatar and the target avatar, such as illustrated in FIG. 12).

While not shown in FIG. 12, some implementations of the configuration environment 1200 enable the user to manipulate cages for purposes of changing an avatar body, such as illustrated in FIG. 2. Various transformation tools may be provided in the configuration environment 1200 to enable the user to click and drag, draw, delete, modify, etc. vertices, etc. of cages.

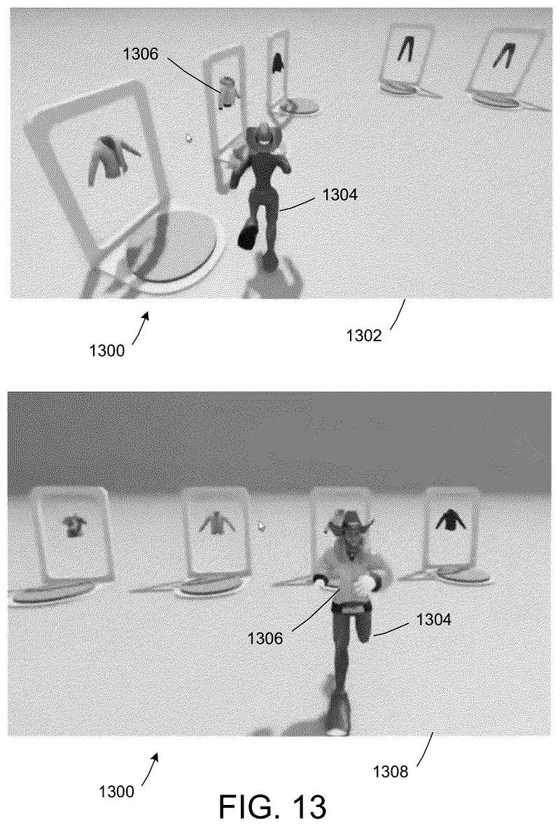

### FIG. 13—Layered Clothing for Avatar Body in Virtual Experience

FIG. 13 illustrates an example of layered clothing for an avatar body of an avatar that participates in a virtual experience 1300, in accordance with some implementations. At 1302, the user's avatar 1304 is a new avatar that has been transformed from a previous avatar, such via the techniques described herein, and is wearing some clothes over the body cage (not shown). An inner cage (not shown) of each outer clothing layer of the avatar 1304 has been deformed, so as to conform/fit each outer clothing layer to the changed/new avatar 1304.

In the virtual experience 1300, the avatar 1304 is running toward a clothing item (e.g., a coat 1306) amongst a selection of other clothing items. When the avatar puts on the coat 1306 at 1308, the coat 1306 is deformed so as to fit over and conform to the underlying clothing layer(s). The deformation of the coat (e.g., cage mapping, cage deformation, etc.) can be performed seamlessly by an engine that runs the virtual experience 1300 and/or by some other component(s), so that the fitting is performed seamlessly from the perspective of the user (e.g., the user need only click on the coat 1306, and the coat 1306 is automatically fitted onto the avatar 1304).

In the foregoing implementations and their examples, an original avatar body is changed to another (new) avatar body, such as by morphing one or more parts of the original avatar body in the manner illustrated and described above. Skinning/meshes and any clothing layers worn by the original avatar body are also deformed so as to conformingly fit the new avatar body.

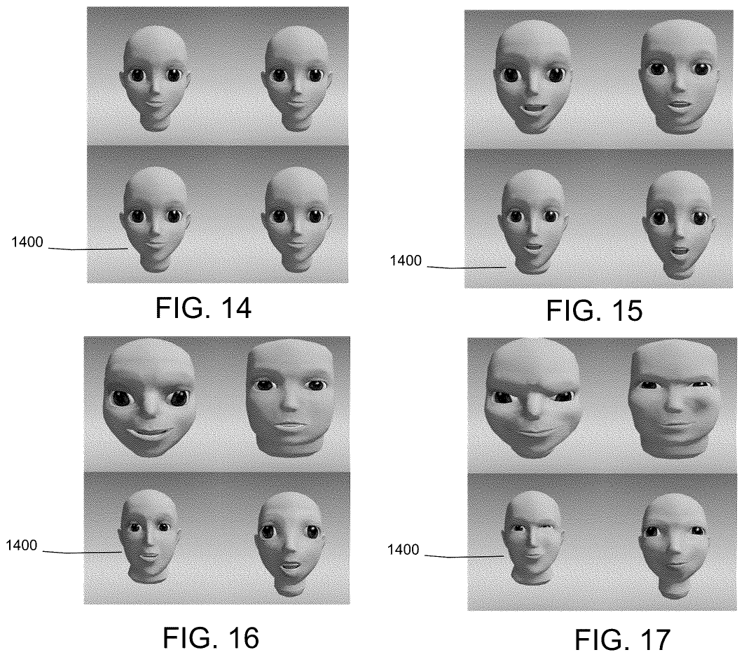

After the geometries (e.g., avatar body, skinning, clothing layers, etc.) are changed/updated, the user may animate the avatar, such as by running, smiling, blinking, waving arms, etc. Examples are provided next in FIGS. 14-17.

### FIGS. 14-17—Transformation and Animation of Avatar

FIGS. 14-17 illustrate examples of transformation and animation of an avatar 1400, in accordance with some implementations. Each of the FIGS. 14-17 illustrate a head of the avatar 1400, and three different versions of the avatar 1400.

In FIG. 14, the avatar 1400 and the other three avatars have not yet been morphed, and so the other three avatars are identical to the avatar 1400. The avatar 1400 in FIG. 14 is expressionless (e.g., neither smiling nor frowning) and has both eyes wide open, and the other three avatars have this same appearance as well.

In FIG. 15, the avatar 1400 is illustrated in its original (non-morphed form) for reference, and the other three avatars are beginning to morph into different head shapes. The avatar 1400 has also been animated so that is now smiling (with lips separated and teeth visible). A corresponding smile is also seen in the animation of the other three avatars.

In FIG. 16, the avatar 1400 is illustrated in its original (non-morphed form) for reference, and the other three avatars continue their morphing into different head shapes, along with smiling animation that corresponds to the smiling animation of the avatar 1400. In FIG. 17, the avatar 1400 is animated to partially blink one eye and to smirk with its lips, and an animation illustrating the same expression is performed on the other three avatars.

According to various implementations, an avatar may be provided with skinning, such that the mesh of the avatar is bound to the joints and bones of the skeleton of the avatar. Thus, movement of the joints/bones of the avatar results in corresponding skin deformations during animation, such as illustrated in FIGS. 15-17 described above. In some implementations, the skeleton of the avatar may be an inferred skeleton made up of virtual joints and virtual bones.

According to various implementations, when the geometry of an avatar body is changed as described in the above examples, such as by changing the geometry/shape of an arm, leg, torso, etc. for a new avatar, the skeleton is also updated for the new avatar. Updating the skeleton (including updating its joints and bones, etc.), as well as updating the skinning, ensures that the new avatar animates accurately such as illustrated in FIGS. 15-17.

In some implementations, such updating may be performed by interpolating attachment positions (e.g., joints) for the new avatar body. Such interpolated attachment positions may be obtained by interpolating between the attachment positions of the skeleton of the original avatar body and the attachment positions of the skeleton of the target avatar body.

In some implementations, interpolation between the vertices of the body cage of the original avatar body and vertices of the body cage of the target avatar body may be performed to obtain the attachment points for the skeleton of the new avatar body. Thus, when an original avatar body is morphed by manipulating its body cage, an analogous morphing can be performed for the skeleton of the original avatar body, so as to reposition the joints and bones of the skeleton.

As an example, a body cage is associated with a mesh of an avatar body, by enveloping the mesh of the avatar body. Hence, the body cage approximates the shape, size, contours, etc. of a body part that is represented by the mesh. Given that with a rig or rigging, the mesh of the avatar is bound to the joints and bones of the skeleton of the avatar, the deformation of the body cage results in a deformation of the corresponding mesh, and the same or similar deformation is applied (due to the binding of the mesh to the skeleton) to the skeleton.

When performing interpolation between the vertices of a pair of cages that have a direct 1:1 correspondence between the vertices, the results of the interpolation provide the vertices for the body cage of the avatar body. Additionally, there may be vertices on the body cage of the original avatar body that have no correspondence with any of the vertices on the body cage of the target avatar body, or vice versa. In such situations, UV correspondence techniques to map between graphical objects or other type of technique may be used to identify the closest vertex to use for interpolation. Aligning the coordinate systems of the pairs of cages may also be performed to further improve the accuracy of the interpolation.

### FIG. 18—Changing Three-Dimensional Avatar Bodies

FIG. 18 is a flowchart illustrating a computer-implemented method 1800 to change three-dimensional (3D) avatar bodies, in accordance with some implementations. For the sake of simplicity, the various operations in the method 1800 are described in the context of a virtual experience (VE) application at a client device performing the operations.

Further, and as is described later below with respect to FIG. 22, some of the operations of the method 1800 and/or any other method described herein may be performed alternatively or additionally, in whole or in part, by a VE engine at a VE platform located at a server. The example method 1800 may include one or more operations illustrated by one or more blocks, such as blocks 1802 to 1806. The various blocks of the method 1800 and/or of any other process(es) described herein may be combined into fewer blocks, divided into additional blocks, supplemented with further blocks, and/or eliminated based upon the implementation.

The method 1800 of FIG. 18 is explained herein with reference to the elements illustrated in FIGS. 2-17 and other figures. In some implementations, the operations of the method 1800 may be performed in a pipelined sequential manner. In other implementations, some operations may be performed out-of-order, in parallel, etc.

At block 1802, a first avatar body that is to be changed is identified. For example, the first avatar body may be the current avatar body of the user, while the user is participating in a virtual experience or while the user is in a configuration environment such as a studio. The first avatar body has a corresponding first body cage. Block 1802 may be followed by block 1804.

At block 1804, a target avatar body is identified. For example, the user may identify a target avatar body in the virtual experience or in a configuration environment. The target avatar body is the body that the user may wish the user's current avatar body to morph into. The target avatar body has a corresponding target body cage. Block 1804 may be followed by block 1806.

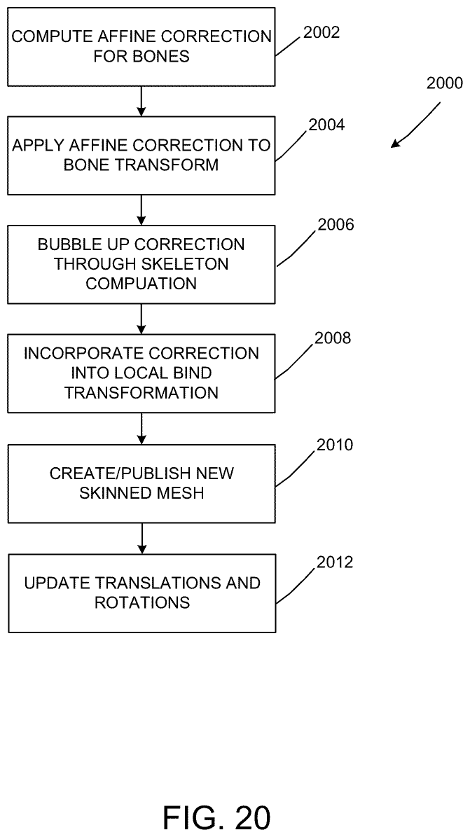

At block 1806, a transformation of the first avatar body is performed. For example, an interpolation may be performed between the first body cage and the target body cage to generate a second body cage corresponding to a second avatar body. Accordingly, the second avatar body can be a blend between the first avatar body and the target avatar body, or fully transformed into the target avatar body. Additional details of how the interpolation may be performed are discussed with respect to FIG. 20.

### FIG. 19—Changing Three-Dimensional Avatar Bodies

FIG. 19 is a flowchart illustrating another computer-implemented method 1900 to change three-dimensional (3D) avatar bodies, in accordance with some implementations. For example, the method 1900 may be used for free-form transformation of an avatar body, without necessarily using a target avatar body as a reference.

At block 1902, a first avatar body that is to be changed is identified. For example, the first avatar body may be the current avatar body of the user, while the user is in a configuration environment such as a studio. In some implementations, the user's avatar may be present in a running virtual experience, and so the avatar may be changed by pausing the virtual experience, by exiting the virtual experience to enter the configuration environment, or by changing the avatar within the running virtual experience itself. The first avatar body has a corresponding first body cage. Block 1902 may be followed by block 1904.

At block 1904, a transformation of the first avatar body is performed. For example, the transformation may be performed by manipulating the first body cage (e.g., repositioning vertices/segments of the first body cage) to generate a second body cage corresponding to a second avatar body. The second body cage may be used to provide a transformation of the first avatar body into the second avatar body. The manipulation may include repositioning portions of the first body cage. Additional details of how the transformation may be performed are discussed with respect to FIG. 20.

### FIG. 20—Clothing Layer Deformed Over Body Cage

FIG. 20 is a flowchart illustrating a computer-implemented method to perform skin morphing, in accordance with some implementations. FIG. 20 is a flowchart illustrating a computer-implemented method 2000 to change three-dimensional (3D) avatar bodies, in accordance with some implementations. For example, the method 2000 may be used for free-form transformation of an avatar body, without necessarily using a target avatar body as a reference. Method 2000 may begin at block 2002.

At block 2002, an affine correction is computed for the bones. For each bone, a 3×4 affine transform is computed that optimally fits the deformation of its influenced point cloud using linear algebra. This may be the Dⱼ term, which may change the skinning computation to better fit the change in the mesh shape. Block 2002 may be followed by block 2004.

At block 2004, the affine correction is applied to a bone transform. This correction is applied to the bone transform in the skinning computation:

$${p}_{i}^{′} = {\sum }_{j = 0}^{4} ( {w}_{i , j} \cdot {D}_{j} \cdot {M}_{j} \cdot {p}_{i} ) .$$

Block 2004 may be followed by block 2006.

At block 2006, the correction is bubbled up through the skeleton computation. Block 2006 may be followed by block 2008.

At block 2008, the correction is incorporated into a local bind transformation. The bubbling up and the incorporation incorporate the correction into a new local bind transform

$${LB}_{j}^{′} ,$$

that generates the same result:

$${LB}_{j}^{′} , = {B}_{j}^{- 1} \cdot {D}_{j} \cdot {B}_{{j}^{′}} \cdot {LB}_{j} .$$

This is algebraic manipulation to remove the Dⱼ transform and replace it with a new bind transform LB′ⱼ that produces the same result, using the original LBS formulation. Block 2008 may be followed by block 2010.

At block 2010, a new skinned mesh is created and/or published. Created just means it exists as a mesh for the local user to see. Published means it is pushed to the Roblox CDN so other users can also see it or purchase it. This requires safety moderation and other processes to use the new skinned mesh in these ways. Block 2010 may be followed by block 2012.

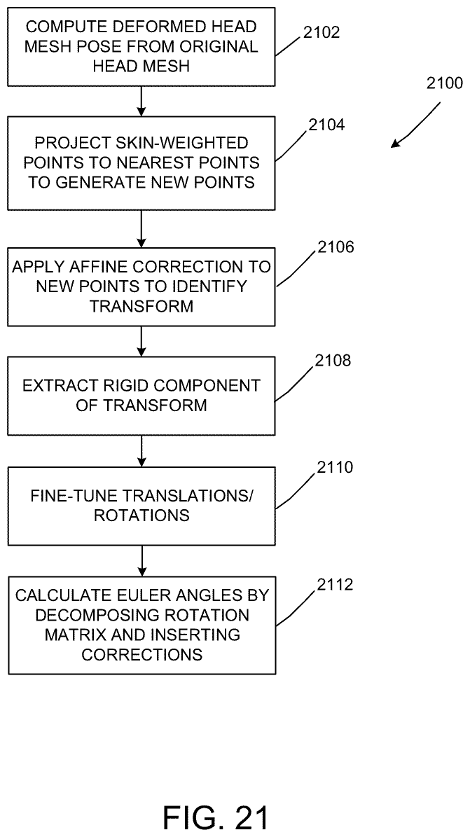

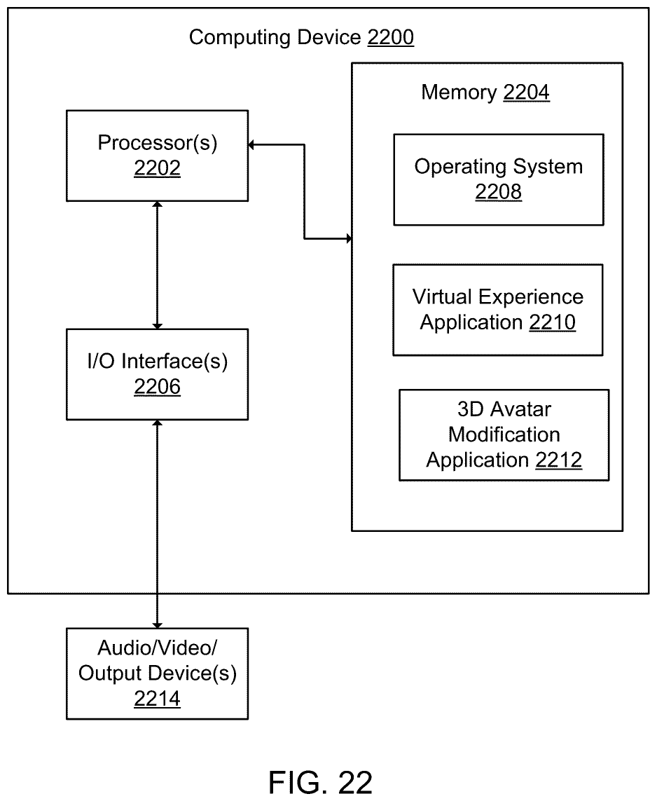

At block 2012, translations and rotations are updated. The FACS rigs contain translations and rotations for every joint in every pose of the rig. After the shape changes, these values need to be updated so the poses continue to work with the new shape. Such updating may be performing using a method 2100, as described with respect to FIG. 21.

### FIG. 21—Clothing Layer Deformed Over Body Cage

FIG. 21 is a flowchart illustrating a computer-implemented method 2100 to perform facial action coding system (FACS) pose morphing. Method 2100 may begin at block 2102.

With respect to FACS pose morphing, the present FACS rigs contain many poses, and each pose includes sets of local transforms Pⱼ for each joint in the head rig. The skin morphing technique updates their bind transforms

$${LB}_{j}^{′} ,$$

which changes the parent space of these local pose transforms. The affine correction transform Dⱼ changes the translation of the resulting Mⱼ transform, both its direction and magnitude, but the affine correction transform Dⱼ does not change the rotation of the resulting Mⱼ transform. To improve the result even further, the per-pose, per-joint rotations r_{j,k} also are to be updated. In that process further fine-tuning the per-pose, per-joint translations t_{j,k} can occur as well. Such a process may be performed one pose at a time.

At block 2102, a deformed head mesh pose is computed from an original head mesh. Specifically, the original LBS deformed mesh pose is computed from the original head shape. The pose is defined as a set of joint transforms. These joint transforms are used with a technique, such as a linear blend skinning technique, to construct the mesh shape in that pose. Block 2102 may be followed by block 2104.

At block 2104, skin-weighted points are projected to nearest points to generate new points. For each joint in the pose, skin-weighted points of the joint are projected to the nearest points on the posed mesh, providing a new set of points. These points represent the locations on the original mesh nearest to the destinations of that joint in that pose. For example, when considering a smile pose, the corner of the mouth slides out into the cheek area. It may be helpful to know how the cheek was reshaped, so it is possible to know if and how the smile pose is to be adjusted in response. Block 2104 may be followed by block 2106.

At block 2106, an affine correction is applied to new points to generate a transform. The same 3×4 affine fit function (used at block 2004) may be used to calculate how these points have transformed between the original shape and the modified shape. Block 2106 may be followed by block 2108.

At block 2108, a rigid component of the transform is extracted. The rigid component of that transform can then be extracted. Some systems, including some rigid body simulation systems, cannot effectively handle scaling and shearing, so those components must be removed before providing the corrections to those systems. Block 2108 may be followed by block 2110.

At block 2110, translations and/or rotations are fine-tuned based on the extracted rigid component. Block 2110 may be followed by block 2112.

At block 2112, Euler angles are calculated by decomposing a rotation matrix and inserting corrections. In order to minimize the changes to the Euler interpolation, a minimal change to the Euler angles that match that rotation is made. These angles are calculated by decomposing the rotation matrix and inserting the corrections incrementally. R=R_{z}_{₁}R_{y}_{₁}Rₓ_{₁}, then R′=R_{z}_{₂}R_{z}_{¹}R_{y}_{₂}R_{y}_{₁}Rₓ_{₂}Rₓ_{₁} (this is showing how the correction rotations, having a subscript 2) are to be incorporated into the rotation calculation), then x′=x₁+x₂, y′=y₁+y₂, and z′=z₁+z₂ (this is showing how the Euler angles from the correction matrices (subscript 2 in the previous equation) can then be directly added to the original rotations, and produce the same result. This is showing a Euler rotation matrix broken down into separate x, y, z rotation matrices. Here, uppercase letters are transformation matrices, and lowercase letters are scalar values.

### FIG. 22—Example Computing Device

FIG. 22 is a block diagram that illustrates an example computing device 2200 which may be used to implement one or more features described herein, in accordance with some implementations. In one example, computing device 2200 may be used to implement a computer device (e.g., 102 and/or 110 of FIG. 1), and perform appropriate method implementations described herein. Computing device 2200 can be any suitable computer system, server, or other electronic or hardware device. For example, the computing device 2200 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, computing device 2200 includes a processor 2202, a memory 2204, input/output (I/O) interface 2206, and audio/video input/output devices 2214.

Processor 2202 can be one or more processors and/or processing circuits to execute program code and control basic operations of the computing device 2200. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 2204 is typically provided in computing device 2200 for access by the processor 2202, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 2202 and/or integrated therewith. Memory 2204 can store software operating on the computing device 2200 by the processor 2202, including an operating system 2208, a virtual experience application 2210, a 3D avatar modification application 2212, and other applications (not shown). In some implementations, virtual experience application 2210 and/or 3D avatar modification application 2212 can include instructions that enable processor 2202 to perform the functions (or control the functions of) described herein, e.g., some or all of the methods described with respect to FIGS. 18-21.

For example, virtual experience application 2210 can include a 3D avatar modification application 2212, which as described herein can dynamically change a 3D avatar within an online virtual experience server (e.g., 102). Elements of software in memory 2204 can alternatively be stored on any other suitable storage location or computer-readable medium. In addition, memory 2204 (and/or other connected storage device(s)) can store instructions and data used in the features described herein. Memory 2204 and any other type of storage (magnetic disk, optical disk, magnetic tape, or other tangible media) can be considered “storage” or “storage devices.”

I/O interface 2206 can provide functions to enable interfacing the computing device 2200 with other systems and devices. For example, network communication devices, storage devices (e.g., memory and/or data store 120), and input/output devices can communicate via I/O interface 2206. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 2214 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 22 shows one block for each of processor 2202, memory 2204, I/O interface 2206, and software blocks of operating system 2208, virtual experience application 2210, and 3D avatar modification application 2212. These blocks may represent one or more processors or processing circuitries, operating systems, memories, I/O interfaces, applications, and/or software engines. In other implementations, computing device 2200 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the computing device 2200, e.g., processor(s) 2202, memory 2204, and I/O interface 2206. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 2214, for example, can be connected to (or included in) the computing device 2200 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., methods 1800, 1900, 2000, and 2100) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (Saas) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to modify three-dimensional (3D) avatar bodies, the computer-implemented method comprising:
identifying a first avatar body having a first body cage;
identifying a target avatar body having a target body cage; and
performing an interpolation between the first body cage and the target body cage to obtain a second body cage corresponding to a second avatar body to provide a transformation of the first avatar body into the second avatar body.

2. The computer-implemented method of claim 1, wherein performing the interpolation comprises performing the interpolation to generate the second body cage that completely matches the target body cage to provide a full transformation.

3. The computer-implemented method of claim 1, wherein performing the interpolation comprises transforming the first avatar body into the second avatar body that is a blend between the first avatar body and the target avatar body to provide a partial transformation.

4. The computer-implemented method of claim 1, wherein performing the interpolation comprises morphing a portion of the first avatar body that is less than an entirety of the first avatar body.

5. The computer-implemented method of claim 4, wherein morphing the portion of the first avatar body that is less than the entirety of the first avatar body comprises morphing the portion of the first avatar body to perform a partial transformation of the portion of the first avatar body.

6. The computer-implemented method of claim 1, wherein the first avatar body is part of a virtual experience, performing the interpolation is performed while the avatar participates in the virtual experience, and the target avatar body is selected from a plurality of target avatar bodies in the virtual experience.

7. The computer-implemented method of claim 1, wherein performing the interpolation is performed in a configuration environment and the target avatar body is selected from a plurality of target avatar bodies in a library in the configuration environment.

8. The computer-implemented method of claim 7, wherein the configuration environment includes a transformation tool that enables a user to control an amount of the transformation of the first avatar body to obtain the second avatar body, and wherein performing the interpolation is based on the amount of the transformation.

9. The computer-implemented method of claim 1, further comprising:
identifying a rig of the first avatar body, the rig comprising identifying a skeleton of the first avatar body and a skinning of the first avatar body;
after performing the interpolation, updating the rig of the first avatar body to correspond to the second body cage; and
animating the first avatar body by moving a skeleton of the updated rig and deforming a skinning of the updated rig.

10. The computer-implemented method of claim 9, wherein moving the skeleton of the updated rig and deforming the skinning of the updated rig comprises reusing skin weights from the skinning of the first avatar body based on determining areas of skinning of the updated rig that are influenced by bones in the skeleton of the first avatar body.

11. A computer-implemented method to modify three-dimensional (3D) avatar bodies, the computer-implemented method comprising:
identifying a first avatar body having a corresponding first body cage; and
performing a manipulation of the first body cage to generate a second body cage corresponding to a second avatar body to provide a transformation of the first avatar body into the second avatar body, wherein the manipulating comprises repositioning portions of the first body cage.

12. The computer-implemented method of claim 11, wherein performing the manipulation is performed in a configuration environment, and wherein the configuration environment includes a transformation tool that enables a user to control aspects of the manipulation of the first body cage to obtain the second body cage, and wherein performing the manipulation is based on the aspects of the manipulation.

13. The computer-implemented method of claim 11, further comprising:
identifying a rig of the first avatar body, the rig comprising identifying a skeleton of the first avatar body and a skinning of the first avatar body;
after performing the manipulation, updating the rig of the first avatar body to correspond to the second body cage; and
animating the first avatar body by moving a skeleton of the updated rig and deforming a skinning of the updated rig.

14. The computer-implemented method of claim 13, wherein moving the skeleton of the updated rig and deforming the skinning of the updated rig comprises reusing skin weights from the skinning of the first avatar body based on determining areas of skinning of the updated rig that are influenced by bones in the skeleton of the first avatar body.

15. The computer-implemented method of claim 13, wherein transforming the first avatar body into the second avatar body comprises performing an interpolation between the first body cage and the second body cage.

16. The computer-implemented method of claim 13, wherein transforming the first avatar body into the second avatar body comprises morphing a portion of the first avatar body that is less than an entirety of the first avatar body.

17. A system, comprising:
a memory with instructions stored thereon; and
a processing device, coupled to the memory, the processing device configured to access the memory and execute the instructions, wherein the instructions cause the processing device to perform operations comprising:
identifying a first avatar body having a first body cage;
identifying a target avatar body having a target body cage; and
performing an interpolation between the first body cage and the target body cage to obtain a second body cage corresponding to a second avatar body to provide a transformation of the first avatar body into the second avatar body.

18. The system of claim 17, wherein performing the interpolation comprises performing the interpolation to generate the second body cage that completely matches the target body cage to provide a full transformation.

19. The system of claim 17, wherein performing the interpolation comprises transforming the first avatar body into the second avatar body that is a blend between the first avatar body and the target avatar body to provide a partial transformation.

20. The system of claim 17, wherein performing the interpolation comprises morphing a portion of the first avatar body that is less than an entirety of the first avatar body.
